(19) United States
(12) Patent Application Publication
(10) Pub. No.: US 2024/0083221 A1
(43) Pub. Date: Mar. 14, 2024

(54) Air Outflow Device for Feeding Tempered Air For an Interior of a Motor Vehicle

(71) Applicant: Mercedes-Benz Group AG, Stuttgart (DE)

(72) Inventor: Joachim CURRLE, Stuttgart (DE)

(21) Appl. No.: 18/261,972

(22) PCT Filed: Nov. 25, 2021
(86) PCT No.: PCT/EP2021/083059

§ 371 Date: Jul. 18, 2023

(30) Foreign Application Priority Data
Jan. 19, 2021 (DE) 10 2021 000 255.5

(51) Int. Cl. B60H 1/34

(52) U.S. Cl. CPC B60H 1/3421; B60H 2001/3471

(57) ABSTRACT

An air outflow device for feeding tempered air for an interior of a motor vehicle includes an electric servomotor, a rotatably mounted rotation ring, and a fixed slide guide. The rotation ring has displaceable fins in an inner region of the rotation ring. A pin of the rotation ring engages with the slide guide and the pin is connected to the fins such that the fins are displaced by a rotation of the rotation ring.

### BACKGROUND AND SUMMARY OF THE INVENTION

The invention relates to an air outflow device for feeding tempered air for an interior of a motor vehicle.

Air outflow devices for an interior of motor vehicles are already known from the prior art. These air outflow devices are designed for tempered air to flow out for a passenger. For this purpose, for example, fins can be designed within the air outflow opening, whereby a direction of the air flow can be adjusted by a passenger.

DE 10 2015 000 874 A1 relates to an air vent for a passenger compartment of a motor vehicle. The air vent has a cylindrical tube-shaped fin carrier having fins pivotally mounted within it. The fin carrier having the fins can be driven in rotation by an electric motor drive. An axially displaceable adjusting ring on the fin carrier enables the fins to be pivoted into any rotation position of the fin carrier. A control cam on a cylinder shifts the adjusting ring via an adjusting slide. The drive of the cylinder is likewise carried out by the electric motor drive, which can optionally be switched to a gear ring to rotate the fin carrier or to the cylinder with a control cam.

The object of the invention is to create an air outflow device, by means of which an improved feed of tempered air can be obtained for a passenger of a motor vehicle.

An aspect of the invention relates to an air outflow device for feeding tempered air for an interior of a motor vehicle, having at least one electric servomotor and having a rotatably mounted rotation ring, wherein the rotation ring has displaceable fins in an inner region of the rotation ring.

It is provided that the air outflow device has a fixed slide guide, with which a pin of the rotation ring engages, such that the fins are displaced by a rotation of the rotation ring.

In particular, an actuated round nozzle for feeding air-conditioned air into the vehicle interior is thus provided. Using the electric servomotor, which in particular is a stepper motor, the rotation ring having fins rotatably mounted thereon can be rotated in a nozzle housing to set any air outflow direction. For this purpose, a guide pin, in particular a pilot pin, is guided via a lever and a corresponding control disc, the guide pin carrying out the pivot movement. If the guide pin has moved in the slide guide, the slant of the fins is first adjusted from minimum to maximum and then back to minimum. The rotation ring is simultaneously rotated one section further.

According to an advantageous embodiment, the slide guide is designed as a star shape.

It is further advantageous if the pin is coupled with a lever that is rotatably mounted with the rotation ring, and the lever is designed to displace the fins.

In a further advantageous embodiment, the rotation ring is connected to a rotation axle by means of at least one strut, wherein the rotation axle is connected to the electric servomotor via at least one gear ring.

It has further proved advantageous if the air outflow direction has a potentiometer, wherein the potentiometer is designed to save a position of the rotation ring and the fins.

A further aspect of the invention relates to a motor vehicle having an air outflow device according to the preceding aspect. The motor vehicle is in particular designed as a passenger car.

Advantageous embodiments of the air outflow device should be seen as advantageous embodiments of the motor vehicle.

Further advantages, features and details of the invention result from the following description of a preferred exemplary embodiment and with reference to the drawings. The features and combinations of features specified previously in the description and the features and combinations of features specified in the following description of figures and/or shown in the figures alone can be used not only in the respectively specified combinations, but also in other combinations or in isolation without leaving the scope of the invention.

### BRIEF DESCRIPTION OF THE DRAWINGS

FIG. 1 shows a schematic front view of an embodiment of an air outflow device; and

FIG. 2 shows a schematic perspective view of a rear side of the air outflow device according to FIG. 1.

### DETAILED DESCRIPTION OF THE DRAWINGS

Identical or functionally identical elements are provided with the same reference numerals in the Figures.

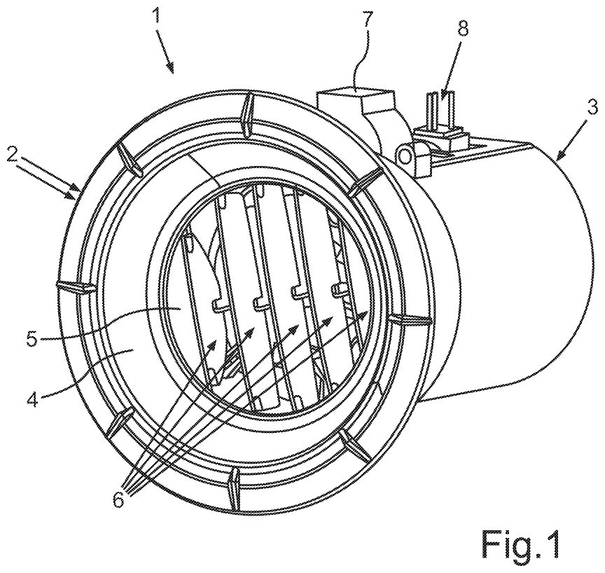

FIG. 1 shows a schematic front view of an embodiment of an air outflow device 1. The air outflow device 1 has a panel 2. The air outflow device 1 further has a nozzle housing 3 and a funnel 4. FIG. 1 further shows that the air outflow device 1 has a rotation ring 5 and displaceable fins 6 that can also be described as a fin packet. The air outflow device 1 further has an electric servomotor 7 that can also be described as a stepped motor, and a potentiometer 8.

The air outflow device 1 is designed to feed tempered air for an interior of a motor vehicle (not depicted).

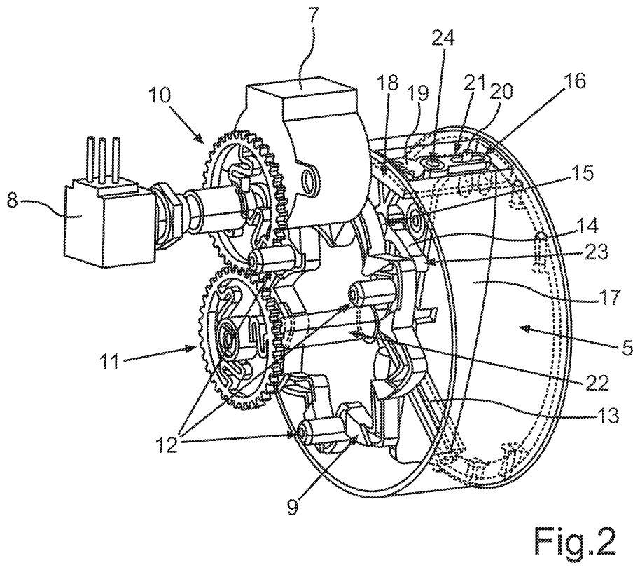

FIG. 2 shows a schematic perspective view of a rear side of the air outflow device 1. In particular, it is presently shown that the air outflow device 1 further has a fixed slide guide 9 that can also be described as a control disc. The air outflow device 1 further has a driving gear wheel 10 and a driven gear wheel 11 and a pin 12. It is further provided that the air outflow device 1 has struts 13 and a lever 14 for moving a control cam. It is further provided that the air outflow device 1 has a further pin 15 and a lever 16 for a control fin 17. The air outflow device 1 further has a first tooth segment 18, a second tooth segment 19 and a control pin 20. It is further shown that the air outflow device 1 has a control pin 20, a slot 21, a rotation axle 22, a guide pin, which can also be described as a pin 23, and a rotation axle 24.

FIG. 2 shows in particular that the air outflow device 1 is designed to feed tempered air for an interior of the motor vehicle. For this purpose, the air outflow device 1 has in particular the electric servomotor 7 and the rotatably mounted rotation ring 5. The rotation ring 5 is coupled with the displaceable fins 6 in an inner region of the rotation ring 5.

The air outflow device 1 has the fixed slide guide 9 in which the pin 23 is connected to the fins 6, such that the fins 6 are displaced by a rotation of the rotation ring 5. The slide guide 9 is in particular designed as a star shape. The pin 23 with the lever 14 is further designed to displace the fins 6. The rotation ring 5 can be connected to the rotation axle 22 by means of the struts 13, wherein the rotation axle 22 is connected to the electric servomotor 7 via at least one of the gear rings 10, 11. It is further shown that the air outflow device 1 has a potentiometer 7, wherein the potentiometer 8 is designed to save a position of the rotation ring 5 and the fins 6.

It is thus in particular shown that a manual operation by a user is not required on the basis of the electric servomotor 7. A passenger can easily set the air outflow direction that is optimal for themselves, for example via voice operation or on a touch screen. A preferred nozzle position can be individually saved and recalled. Actuated nozzles, such as the air outflow device 1, can additionally be connected to the climate control. Individualization and improvement of the thermal comfort for a passenger results as a whole. The air-conditioning energy contained in the air current flowing out of the air outflow device 1, for example warm or cold air, is additionally brought to the passenger more efficiently, whereby energy can be saved for air-conditioning the vehicle interior.

The solution consists in particular of the air outflow device 1 presented, which requires only the electric servomotor 7 to set any or a limited number of discrete outflow directions of the exiting air. This leads to a clear reduction in costs compared with solutions in which the vertical deflection is accomplished by a stepped motor and the horizontal deflection is accomplished by a further stepped motor. In the entrance region of the air outflow device 1, air-conditioned air flows from the heating and climate control unit of the vehicle, while the electric servomotor 7 and the potentiometer 8 are housed in the air-conditioning element depicted. In the nozzle housing 3, the rotation ring 5 in which the fins 6 are mounted can be rotated by means of the electric servomotor 7. Any outflow direction of the air can be obtained via this rotation and steering of the fins 6 of the fin packet. The funnel 4 and the panel 2, which is connected to an instrument panel of the motor vehicle, are located in the front region of the air outflow device 1.

The rotation movement generated in the electric servomotor 7 is transferred to the driven gear wheel 11 via the driving gear wheel 10 and to the rotation ring 5 via the rotation axle 22. The rotation axle 22 is fixedly connected to the rotation ring 5 via the struts 13. The lever 14 and the pin 23 connected to the fixed rotation ring 5 are rotatably mounted. On one end, the lever 14 has a guide pin that in particular presently corresponds to the pin 23, which is connected to the nozzle housing 3 in the slide guide 9, wherein this is in particular respectively obtained via the pin 12. The pin 23 engages with the star-shaped slide guide 9. On its other end, the lever 14 has the tooth segment 18, which engages with the tooth segment 19 of the lever 16 mounted rotatably around the axle 24, via which the control fin 17 is steered via the control pin 20 and the entire fin packet, and thus the fins 6, are steered via a driver. The control pin 20 moves into the slot 21 of the lever 16. This means that the fin packet is simultaneously steered to different degrees depending on the position of the pin 23 via the lever 14, 16 and the pin 23 guided in the slide guide 9. The current position of the kinematics is saved by the potentiometer 8 after the voltage supply is switched off, such that the system can further be operated from this position after it is switched on again.

As a whole, the Figures show an actuated round nozzle.

1.-5. (canceled)

6. An air outflow device (1) for feeding tempered air for an interior of a motor vehicle, comprising:
an electric servomotor (7);
a rotatably mounted rotation ring (5), wherein the rotation ring (5) has displaceable fins (6) in an inner region of the rotation ring (5); and
a fixed slide guide (9), wherein a pin (23) of the rotation ring (5) engages with the slide guide (9) and wherein the pin (23) is connected to the fins (6) such that the fins (6) are displaced by a rotation of the rotation ring (5).

7. The air outflow device (1) according to claim 6, wherein the slide guide (9) has a star shape.

8. The air outflow device (1) according to claim 6, wherein the pin (23) is coupled with a lever (14) that is rotatably mounted with the rotation ring (5) and wherein the fins (6) are displaceable by the lever (14).

9. The air outflow device (1) according to claim 6, wherein the rotation ring (5) is connected to a rotation axle (22) by a strut (13) and wherein the rotation axle (22) is connected to the electric servomotor (7) via at least one gear ring (10, 11).

10. The air outflow device (1) according to claim 6, further comprising a potentiometer (8), wherein a position of the rotation ring (5) and the fins (6) are saveable by the potentiometer (8).
